(19) United States
(12) Patent Application Publication
(10) Pub. No.: US 2014/0251554 A1
(43) Pub. Date: Sep. 11, 2014

(54) Door Cover Device

(71) Applicants: Peter M Rainaldi, Ramsey, NJ (US); David Valentin, Mahwah, NJ (US)

(72) Inventors: Peter M Rainaldi, Ramsey, NJ (US); David Valentin, Mahwah, NJ (US)

(21) Appl. No.: 14/285,219

(22) Filed: May 22, 2014

Related U.S. Application Data
(63) Continuation-in-part of application No. 13/285,042, filed on Oct. 31, 2011, now abandoned.

(51) Int. Cl. E06B 5/00

(52) U.S. Cl. CPC E06B 5/00
USPC 160/103

(57) ABSTRACT

A door cover is useful for covering a door that one would like to hide for various reasons not limited to dings, nicks, scratches, color fading, paint chipping, or simple dislike of design or color. In addition to the utility of hiding an aspect of a door, the door cover also offers an easy, cheap, and quick method of securely fastening a new style to a door. This new style can consist of endless artistic opportunities, not limited to numerous different colors, materials, patterns and textures. The fitted door cover can accommodate any style imaginable, to include any artist style, holiday representations, represent political affiliations, sporting loyalties, characters, brands, logos, as well as many other possible expressions of individuals, such as monograms.

### REFERENCE TO RELATED APPLICATION

This application is a continuation-in-part of U.S. patent application Ser. No. 13/285,042, filed Oct. 31, 2011.

### FIELD OF INVENTION

The present invention relates generally to devices that cover doors. More specifically, this invention relates to a door covering that conceals imperfections or negative aspects of a door, while allowing for a display of style brand, character, logo, and/or design at the same time.

### BACKGROUND OF THE INVENTION

Various types of covers are well known in the art. For example, U.S. Pat. No. 4,475,768 to Webb discloses a fitted seat cover, which is secured to the underside of a seat using Velcro. The utility of the invention is to allow the user to adapt the chair to its environment or be able to change décor at any moment. U.S. Pat. No. 5,922,437 to Bryant relates to fitted covers for household items using a pliable material comprising a bag-like structure with an opening. Patent U.S. Pat. No. 5,713,615 to Tsai describes a stretchable door knob cover useful for improving the appearance and operation of a doorknob by means of a cover. U.S. Pat. No. 6,714,167 issued to Gusick describes a satellite dish cover using a decorated fabric.

However, there is a need for a device used to cover a door that is easier to apply and remove, while still being easy and inexpensive to manufacture. One of the objects of this device is to satisfy this need.

### SUMMARY OF THE INVENTION

The present invention is directed to a fitted cover for doors and other similarly shaped items. The fitted cover secures to a door by means of four elastic corners snuggly covering the corners of a door and has a piece of material in at least one corner attached thereto and protruding outward therefrom for aiding the securing and then removal of the cover from the door. The snug fit of this invention allows the cover to remain in place, despite frequent opening, closing and possible slamming of a door. This fitted door cover serves the purpose of hiding warps, scratches, dings, cracked, broken, old, and generally unpleasant looking doors, and/or to be able to change decor at any moment. At the same time the present invention is useful for hiding unpleasantries of a door, it also has the potential to offer a fresh attractive look. The fitted door cover can vary in aesthetic design, to include different colors, materials, patterns and textures. The fitted door cover can accommodate any style imaginable, to include any artist's style, holiday representations, represent political affiliations, sporting loyalties, brands, logos, characters, slogans, word phrases, images, reproduction of photograph images, as well as many other possible expressions of individuals, such as monograms.

The device can display one or more designs or images consisting of letters, words, and/or images. The fitted cover allows for one to adapt the door to its environment, and to change the style quickly, easily and cheaply. The fitted cover is easy to maintain and transform. Other similarly shaped items which the fitted cover could accommodate include cupboards, windows and drawers. Still further uses and advantages will become apparent from a consideration of the ensuing description and drawings. The device is reusable.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 shows a frontal view of the door 7 wearing the door cover 1 with the outer view of the door cover 1 showing, which may contain visual information 3. Also shows doorpost or frame 9 and doorknob 5.

FIG. 2 shows a frontal view of the door 7 wearing the door cover 1 with an optional doorknob cutout with elastic around the edge of the cutout 15.

FIG. 3 shows the side view of the door 7 wearing the door cover 1, exposing the connection between fitted elastic corners, comprising the inner elastic material of the door cover 11, and the four corners of the door 7, both frontal and back views, and has a pull tab, comprising a piece of material 13 in one corner attached thereto and protruding outward therefrom for pulling the fitted corners 11 over the door corners 7, and thus aiding the securing and then removal of the cover 1 from the door 7.

FIG. 4 shows a rear view of the door 7 wearing the door cover 1 including the elastic component fitted corners 11, which secure the cover to the door, and has the pull tab 13 in one corner protruding outward therefrom.

FIG. 5 shows a frontal view of the door 7 wearing the door cover 1 with the outer view of the door cover 1 showing and also shows pull tabs 13 in four corners attached thereto and protruding outward therefrom for pulling the fitted corners 11 over the door corners 7, and thus aiding the securing and then removal of the cover 1 from the door 7.

FIG. 6 shows a rear view of the door 7 wearing the door cover 1, exposing the connection between the fitted elastic corner 11 and the four corners of the door, and has tabs 13 in four corners attached thereto and protruding outward therefrom for pulling the fitted corners 11 over the door corners 7, and thus aiding the securing and then removal of the cover 1 from the door 7.

### DETAILED DESCRIPTION OF THE PREFERRED EMBODIMENT

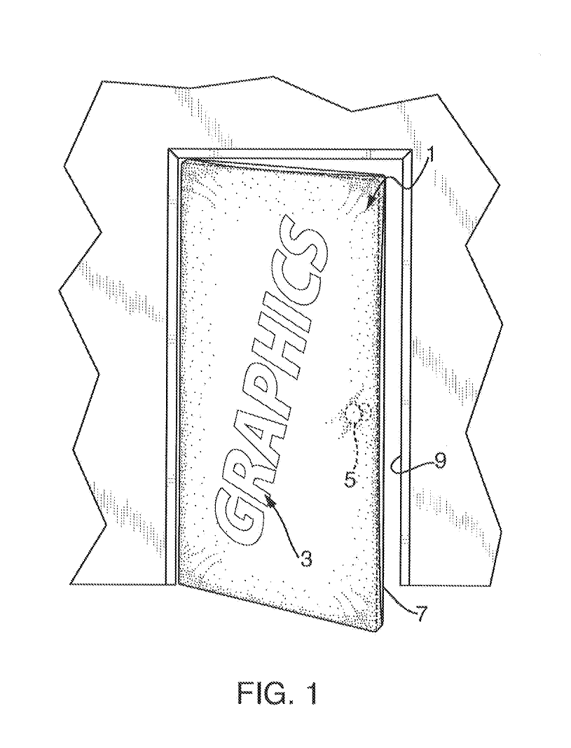

FIG. 1 shows a standard door 7 with a frontal view wherein the inner view of the cover 1 will connect and be secured to. The perimeter of the cover is made to coincide with the rim of the door. A standard door which can be an entry door that is typically 80″ high×36″ wide. Interior doors are typically 80″×30″, 28″, 32″ or 34″, or in that range, also shown is the possibility that visual information, indicia, and/or graphics 3 can be on the outer view of the door cover. This can include but is not limited to aesthetic designs which include a multitude of different colors, materials, patterns and textures. The fitted door cover 1 can accommodate any style imaginable, to include any artist style, holiday representations, represent political affiliations, sporting loyalties as well as many other possible expressions of individuals, such as monograms. The fitted cover allows for one to adapt the door to its environment, and to change the style quickly, easily and cheaply.

The fitted cover 1 is easy to maintain and transform. The fitted door cover 1 is intended to cover, mask, or conceal negative aspects of the door, and/or be able to change the decor of the door at any moment. For example, a door might be damaged by a large scratch and too expensive to replace. Also a door might be a wrong color, cracked, faded, have paint chipping. It might have a ding or a dent, it might even have a hole. Any of these features can easily be hidden with a door cover 1.

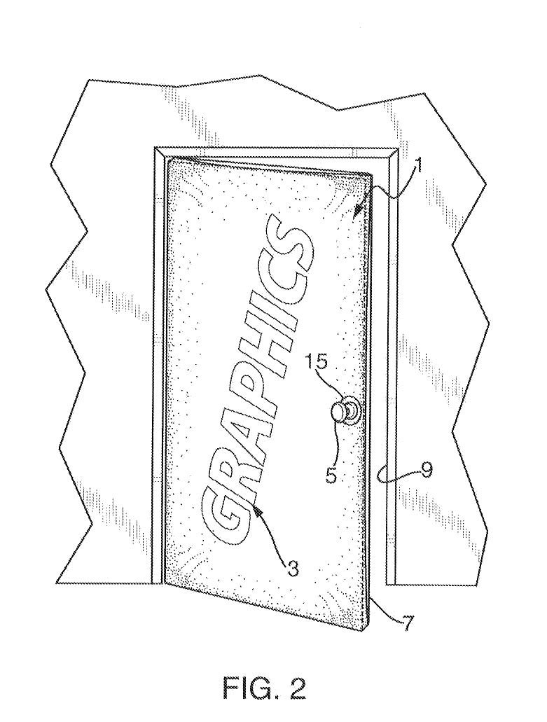

FIG. 2 shows the frontal view of a standard door 7, wherein the inner view of the cover 1 will connect to and be secured to. It also shows the doorknob 5 and how the cover can have a perimeter cut out with elastic material 15 to surround and perfectly fit a doorknob 5.

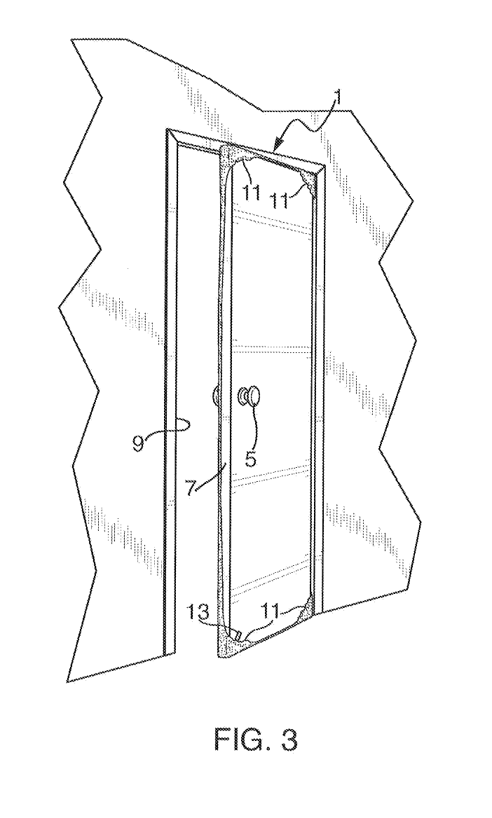

FIG. 3 shows the side view of the door 7 wearing the door cover 1, exposing the connection between the inner elastic material comprising the elastic fitted corners of the door cover 11 and the four corners of the door 7, both frontal and back views and has a piece of material in one corner, comprising a pull tab 13 attached thereto and protruding outward therefrom for pulling the fitted corners 11 over the door corners 7, and thus aiding the securing and then removal of the cover 1 from the door 7. FIG. 3 shows how the elastic fitted corners 11 make contact with and is attached tightly and securely to the frontal and back four corners of the door 7.

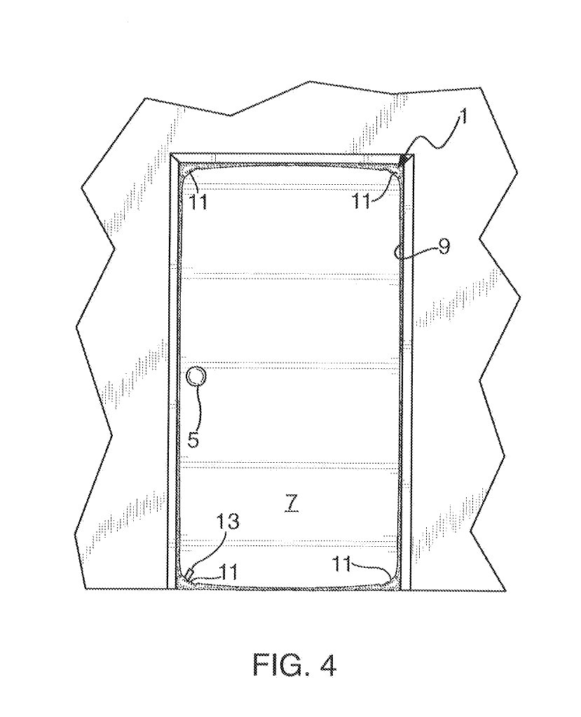

FIG. 4 shows a rear view of the door cover 1 including the elastic fitted corners 11, which secures the cover to the door, and has the pull tab 13 in one corner protruding outward therefrom.

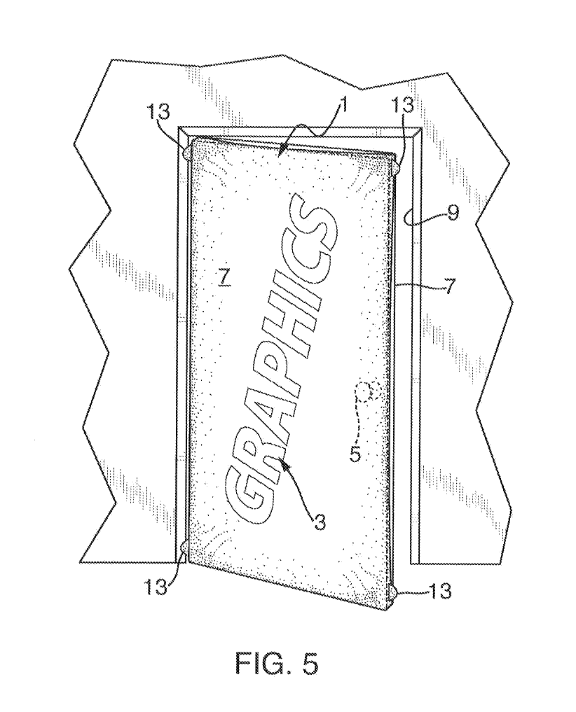

FIG. 5 shows a frontal view of the door 7 wearing the door cover 1 with the outer view of the door cover showing and also shows the pull tabs 13 in four corners attached thereto and protruding outward therefrom for pulling the fitted corners 11 over the door corners 7, and thus aiding the securing and then removal of the cover 1 from the door 7.

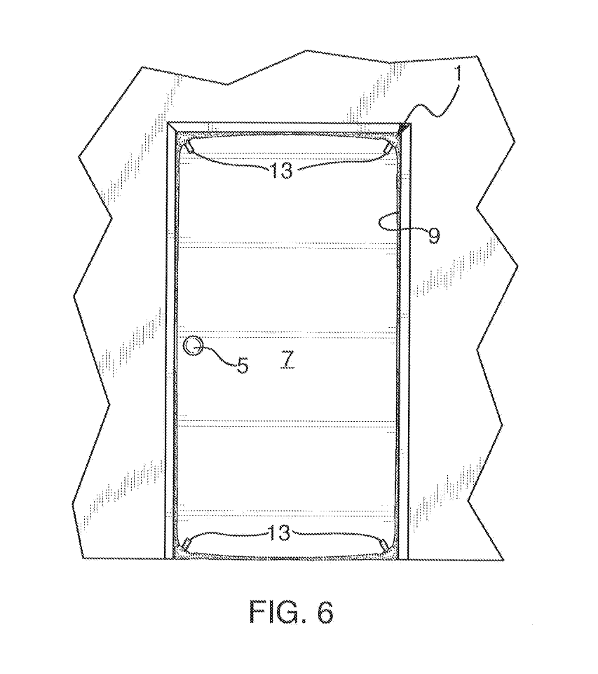

FIG. 6 shows a rear view of the door 7 wearing the door cover 1, exposing the connection between the elastic fitted corners of the door cover 11 and the four corners of the door 7, and has a pull tab in each of the four corners 13 attached thereto and protruding outward therefrom for pulling the fitted corners 11 over the door corners 7, and thus aiding the securing and then removal of the cover 1 from the door 7.

The elastic fitted corners 11 of the door cover 1 are formed by creating a seam at each corner of the door cover 1 and sewing stretched elastic bands or strips into the seams, such that in the slackened state the fitted corners draw together, forming folds or wrinkles The elastic fitted corners 11 are formed substantially in the manner used to make fitted corners for bed sheets, as described in U.S. Pat. No. 4,682,555 to Bierbaum, et al., the disclosure of which is incorporated herein by reference.

Optionally, the door cover 1 can be reversible, with different indicia and/or graphics on either side of the door cover, so as to provide a changeable appearance.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A door cover for covering a front side of a door having four door corners, the door cover comprising:
a rectangular sheet of textile or plastic material substantially conforming in dimensions to the front side of the door;
wherein the sheet has an obverse side and a reverse side, and wherein the obverse side has imprinted thereon a display comprising one or more indicia or graphics, or a combination of indicia and graphics;
wherein the sheet has four sheet corners, corresponding to the four door corners, and wherein each sheet corner comprises an elastic fitted sheet corner, which stretchably engages and encompasses a corresponding door corner, thereby securing the door cover to the door, such that the door cover covers the front side of the door and makes the display visible thereon.

2. The door cover of claim 1, wherein the sheet has a knob aperture, which is aligned with a doorknob of the door, and which has an elastic perimeter which stretchable engages and encompasses the doorknob.

3. The door cover of claim 1 wherein one or more of the elastic fitted sheet corners has a protruding pull tab, which is manually pulled in order to stretch the elastic fitted sheet corner over the corresponding door corner.

4. The door cover of claim 1, wherein the sheet is reversible, such that either the obverse side or the reverse side can be visible, and wherein the reverse side has imprinted thereon a display comprising one or more indicia or graphics, or a combination of indicia and graphics.
